(19) United States
(12) Patent Application Publication
(10) Pub. No.: US 2010/0201984 A1
(43) Pub. Date: Aug. 12, 2010

(54) IN-LINE HIGH PRESSURE PARTICLE SENSING SYSTEM

(75) Inventors: Felix Schuda, Saratoga, CA (US); DelRae Gardner, Tualatin, OR (US); Craig C. Ramsey, West Linn, OR (US); Dennis J. Bonciolini, Tigard, OR (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CYBEROPTICS SEMICONDUCTOR, INC., Wilsonville, OR (US)

(21) Appl. No.: 12/692,715

(22) Filed: Jan. 25, 2010

Related U.S. Application Data
(60) Provisional application No. 61/151,629, filed on Feb. 11, 2009.
(60) Provisional application No. 61/262,764, filed on Nov. 19, 2009.

(51) Int. Cl. G01N 21/49; G01N 1/10

(52) U.S. Cl. 356/338; 356/246

(57) ABSTRACT

An in-line particle sensor includes a sensor body, an illumination source, an illumination detector and communication electronics. The sensor body has an electronics enclosure and a flowthrough portion with a fluid inlet, a fluid outlet, a sample interaction region and a fluid path extending through the sample interaction region from the fluid inlet to the fluid outlet. The illumination source is disposed to provide light through at least a portion of the sample interaction region. The illumination detector is disposed to detect illumination variation resulting from illumination impinging at least one particle in the flow path in the sample interaction region. The communication electronics are operably coupled to the illumination detector to provide an indication of the at least one particle sensed by the illumination detector. The sample interaction region is configured to withstand high operating pressure.

### CROSS-REFERENCE TO RELATED APPLICATIONS

The present application is based on and claims the benefit of U.S. provisional patent application Ser. No. 61/151,629, filed Feb. 11, 2009, and U.S. provisional patent application Ser. No. 61/262,764, filed Nov. 19, 2009, the contents of which are hereby incorporated by reference in their entireties.

### BACKGROUND

The leading edge of the semiconductor processing industry is currently advancing production to the 45 nanometer scale. Further, development is currently under way at 32 nanometer and 22 nanometer scales. Accordingly, it is becoming increasing critical that semiconductor processing tools and the processing itself be controlled to tolerances and conditions never previously required. The cost of wafer scrap and maintenance downtime continues to drive the desire to control processes and equipment to tighter levels, and as other problems arise that were insignificant to processes above 100 nanometers, process and equipment engineers look for new and innovative ways to better control semiconductor processing.

During the manufacture of semiconductor wafers, there are multiple tools and processes to which a wafer is exposed. During each of these steps, there are potential defects that may be caused by dirty equipment and/or process conditions that can cause degradation in the yield of the final integrated circuit devices due to microscopic particles being deposited on the wafer's surface. Thus, it is critical to keep all process stages and steps as clean as reasonably possible and to be able to monitor the condition of these various stages before committing wafers to the process. This is important because each wafer may contain the circuitry for tens or even hundreds of integrated circuit devices, and a single lost wafer may result in hundreds or thousands of dollars worth of scrap.

### SUMMARY

An in-line particle sensor includes a sensor body, an illumination source, an illumination detector and communication electronics. The sensor body has an electronics enclosure and a flowthrough portion with a fluid inlet, a fluid outlet, a sample interaction region and a fluid path extending through the sample interaction region from the fluid inlet to the fluid outlet. The illumination source is disposed to provide light through at least a portion of the sample interaction region. The illumination detector is disposed to detect illumination variation resulting from illumination impinging at least one particle in the flow path in the sample interaction region. The communication electronics are operably coupled to the illumination detector to provide an indication of the at least one particle sensed by the illumination detector. The sample interaction region is configured to withstand high operating pressure.

### BRIEF DESCRIPTION OF THE DRAWINGS

FIG. 1 is diagrammatic view of an in-line particle sensing system for semiconductor processing systems in accordance with an embodiment of the present invention.

FIG. 2 is a perspective view of an in-line particle sensing tool for semiconductor processing systems in accordance with an embodiment of the present invention.

FIG. 3 is a diagrammatic view of particle detection in accordance with an embodiment of the present invention.

FIG. 4 is a diagrammatic view of another embodiment of particle detection in accordance with the present invention.

FIG. 5 is a diagrammatic view of components of an in-line particle sensing system in accordance with an embodiment of the present invention.

FIG. 6 is a diagrammatic view of a semiconductor processing tool employing in-line sensing system in accordance with an embodiment of the present invention.

### DETAILED DESCRIPTION OF ILLUSTRATIVE EMBODIMENTS

As set forth above, it is critical to keep all process stages and steps clean and to monitor the condition of the stages before committing wafers to the process. Additionally, it is also valuable to provide a real-time system that can monitor one or more process chemical delivery systems that are providing specialty gases or chemicals to the semiconductor processing tools and setting limits for contamination particulates with a system that can transmit, wirelessly or otherwise, the data to a central monitoring station.

Existing particle measurement systems are believed to be primarily intended as laboratory or diagnostic equipment. Many such systems are designed to measure free air. It is believed that some systems are available that measure particulates in gas or fluid flow lines. However, these systems are relatively large, expensive, and require training for use. Additionally, these systems are not ruggedly constructed and usually require venting the gas that has been measured. In short, such currently-available systems require much more care and maintenance than can be provided in an industrial environment on a continuous basis.

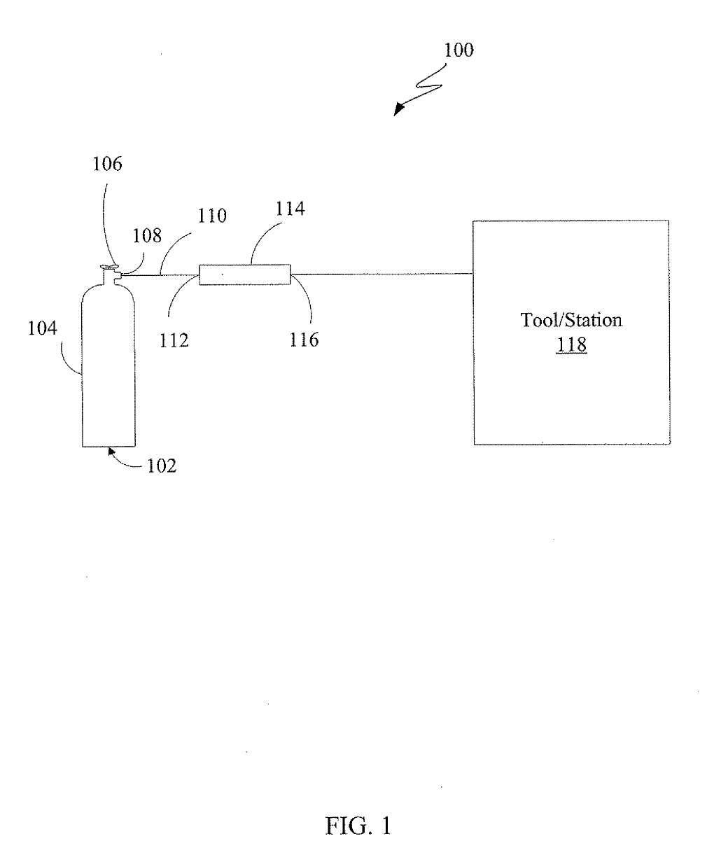

FIG. 1 is a diagrammatic view of a semiconductor processing system employing an in-line particle sensing system in accordance with an embodiment of the present invention. System 100 includes a source of specialty process gas or chemical 102 disposed within bottle or other suitable structure 104. A valve, illustrated diagrammatically at reference numeral 106, allows the gas or process chemical within bottle 104 to pass through outlet 108 into line 110. In some applications, line 110 may also include a pressure regulator (not shown) as appropriate. Line 110 feeds an inlet 112 of in-line particle sensor 114 which measures or senses particulates entrained in the gas or process chemical passing therethrough. All such measured gas and/or chemical exits outlet 116 of sensor 114 and is provided to semiconductor tool/station 118.

Examples of processes that are used in semiconductor device fabrication include physical vapor deposition (PVD), chemical vapor deposition (CVD), electrochemical deposition (ECD), atomic layer deposition (ALD), and molecular beam epitaxy (MBE), as well as others. Each such process may require a different type or form of specialty chemical or gas for its process. Additionally, the utilization of different types of gas for a given type of process may yield different results. Accordingly, semiconductor processing may employ a wide array of specialty gases and/or chemicals provided within bottles 104 for semiconductor processing. However, all such materials must be provided with exceedingly high cleanliness.

When a semiconductor wafer is scrapped due to contamination caused by excessive particulates, the entire process to which the wafer was exposed must be analyzed in detail. Since particles could come from many different potential sources of contamination, as well as mechanical collisions within the semiconductor tool, establishing the root cause of such contamination is generally quite difficult. Certainly, since the process gases and specialty chemicals are used for processing, they can be a source of such contamination. Providing an efficient way in which the cleanliness of the process gas or specialty chemical could be verified, either real-time or on an historic basis, would provide a significant benefit in assuring quality during the manufacture of semiconductor wafers and/or reducing the amount of analysis that would be required if the contamination actually occurs.

As set forth above, it is believed that some particulate sensors have been employed that split a portion of the process gas or specialty chemical from the high-pressure stream and monitor particulates in the split portion. The assumption is that if particulates are detected in the split-off portion, that particulates are also present in the non-split portion that is used for processing. However, when the cleanliness levels become exceedingly high, that assumption may not always be true. For example, a few particles may follow the split portion and thus be detected when in fact the non-split portion of process gas or specialty chemical does not contain particles. Conversely, it is also possible that particles would not follow the split portion, and thus not be detected but still provide contamination to the semiconductor tool or process. The benefit of splitting a portion of process gas off for particulate detection is that the pressure of the gas can be reduced to levels that can accommodate current commercially-available particle sensors without destroying them. However, once the gas passes through the particle sensor, it may have mixed with air, or some other gas, and thus would no longer be suitable to be reinjected into the process. Another reason that the gas would not be re-injected into the process is that once the pressure has been lowered to accommodate an available particle detection sensor, the gas would have to be repressurized before it could be reinjected. Moreover, the pressurizing process itself would be a possible source of contamination or particles and thus would be undesirable. Accordingly, the measured gas is discarded or safely vented.

Embodiments of the present invention are considered in-line in that all of the process gas or specialty chemical from a given bottle 104 or suitable container passes through the sensor and is conveyed onto the appropriate tool or semiconductor processing station 118. Accordingly, as indicated in FIG. 1, sensor 114 includes an inlet 112 and an exit 116 through which all of the particular specialty chemical or process gas flows. Notably, sensor 114 does not include a vent or other suitable structure that allows the inlet flow at inlet 112 to be greater than the exit flow 116.

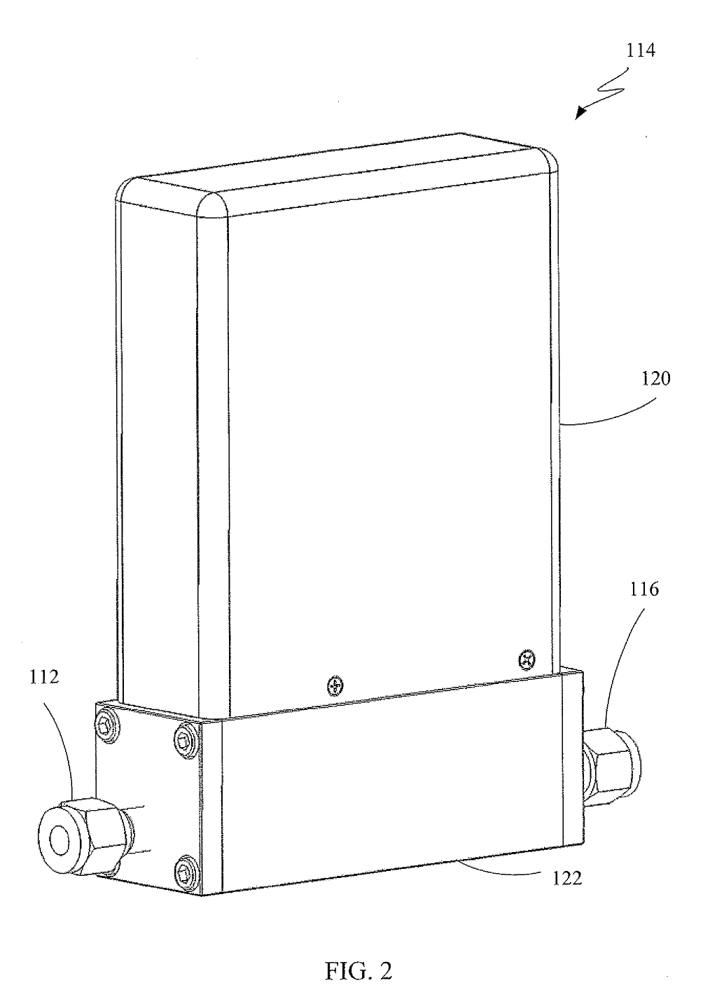

FIG. 2 is a perspective view of an in-line particle sensor in accordance with an embodiment of the present invention. Sensor 114 includes electronics enclosure 120 as well as flow-through portion 122. Flow-through portion 122 includes inlet 112 and outlet 116 and is preferably constructed from metal. More preferably, flow-through portion 122 is constructed from a single piece of stainless steel. As illustrated in FIG. 2, inlet 112 and outlet 116 are preferably standardized inlets that can be coupled to flow lines in much the same manner as mass flow controllers and other suitable devices are coupled to specialty chemical and processing gas lines in semiconductor processing systems. Preferably, flow-through portion 122 is relatively rectangular and is shaped and sized to mount in gas panels in a way similar to common gas valves and flow components, such as mass flow controllers.

Mass flow controllers are the basic building block of many semiconductor and industrial gas flow systems. Mass flow controllers have a quasi-standard shape to facilitate mounting and connection to the gas systems. Mass flow controllers are also controlled by and report to a central control system. In accordance with embodiments of the present invention, the in-line particle sensing system and mass flow controllers are intended to be used together. This allows the particle detection information to be related to flow rate and thus the particles information can be provided in terms of particles per volume or mass of flow.

In some embodiments, the in-line particle measurement system physically resembles a mass flow controller. For example, inlet 112 and outlet 116 are preferably centered ½ inch above the base. The width of flow-through portion 122 is preferably less than 38 mm, and the length of portion 122 is preferably less than 200 mm. The height of the entire device (flow-through portion 122 and electronics enclosure 120) is preferably less than 180 mm and more preferably less than 160 mm. While a mass flow controller measures and controls the gas or fluid flow, the in-line particle sensing system reports on particulate presence and/or concentration and thereby prevents damage to sensitive equipment and products.

The in-line particle sensing system, in accordance with embodiments of the present invention, may be used continuously or intermittently. Further, the inline particle sensing system may be used at the point of gas use or disposed anywhere along the gas line. Further still, the sensor may be directly connected to the gas bottle before the first valve, in an environment where it is continuously subjected to very high pressure (on the order of 3000 pounds per square inch). Through material selection and/or other design considerations, embodiments of the present invention may also provide the ability to withstand high temperatures as well. In contrast to other devices, embodiments of the present invention provide a system and method that provides real-time particle information. This information can be used to direct feedback to the process/facilities engineer as to the condition of many critical fluids in the semiconductor fab. Embodiments of the present invention can be used fab-wide and may even be sealed and used in wet applications as well. Currently, the some particle counters that are commercially available require a relatively high airflow to count particles in the fab environment. However, no method is believed to exist for direct wireless measurement in chemical delivery lines. Further, currently-available gas or fluid particle monitoring systems are not believed to be able to withstand high gas pressures and are not intended for permanent installation in environments that are potentially dangerous if hazardous gases are being monitored. In contrast, embodiments of the present invention provide a device that can be permanently installed in high-pressure lines and can withstand very high pressures for extended periods of time.

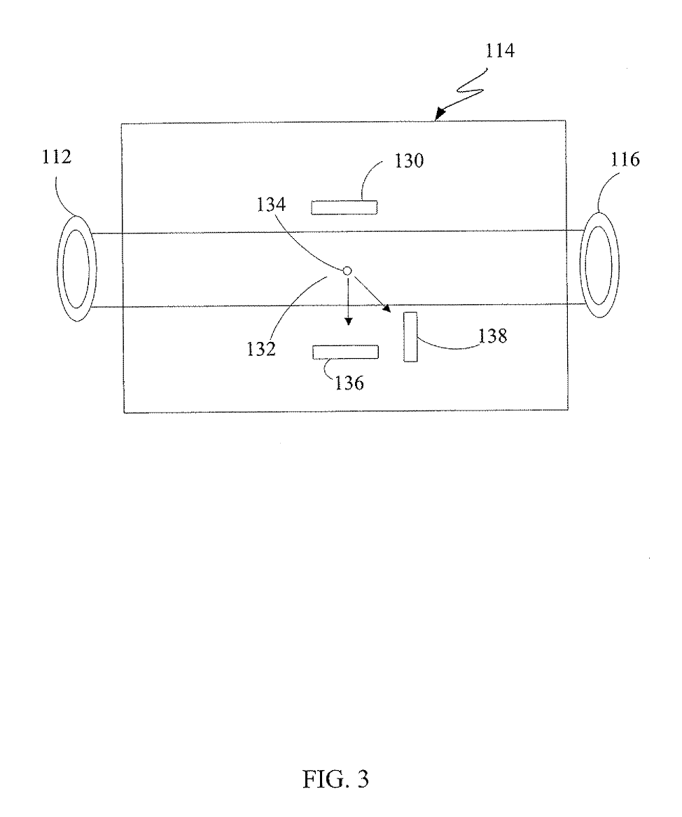

FIG. 3 is a diagrammatic view of in-line particle sensing system 114 in accordance with an embodiment of the present invention. While the flow of gas is illustrated diagrammatically as passing from inlet 112 straight to outlet 116, in fact, the flow passageway need not be straight. Illumination source 130 is preferably a laser, and more preferably is a diode laser. However, embodiments of the present invention can be practiced where source 130 is an LED or other suitable light source. The wavelength of the light and the size of the particles of interest is generally considered in the selection of source 130. In general, short wavelengths are preferred since process technology is advancing to smaller and smaller particle dimensions. Preferably, the wavelength of the illumination is generally shorter, such as in the blue or ultraviolet ranges since smaller-wavelength illumination will be more scattered by particles. As illustrated in FIG. 3, source 130 is disposed to preferably direct illumination in a direction that is substantially orthogonal to the direction of fluid flow in flow interaction region 132. It is preferred that illumination from source 130 is shone through a transparent tube or window that is preferably formed of a transparent material such as glass, quartz, sapphire, silicon carbide (SiC), or other suitable material that is part of the liquid/gas delivery system so that what is seen is real-time data from the flow of fluid past the interaction region 132. As a particle (such as that illustrated diagrammatically at reference numeral 134) enters interaction region 132, it will scatter or otherwise interrupt the relative amount of light falling on detector(s) 136, 138. This momentary fluctuation in the intensity of illumination measured by detectors 136, 138 is detected by suitable detection circuitry (not shown in FIG. 3) to count or otherwise detect the presence of particle 134. When there is no particle in the beam, no scattered light would be detected. As illustrated in FIG. 3, a plurality of detectors 136, 138 may be provided. Moreover, the different detectors can be provided at different angular orientations relative to the direction of illumination from source 130. As can be seen, detector 136 will generally detect a steady-state amount of illumination when no particles are present. As particles interrupt the beam of light, detector 136 will register a decrease in illumination that is measured. In contrast, detector 138 is disposed at an angle (illustrated as relatively ninety degrees) with respect to detector 136. When no particles are present, detector 138 does not detect any illumination. However, when particle 134 scatters illumination, detector 138 will detect the scattered illumination. In a preferred embodiment, a single detector 138 is used to detect particles. Those skilled in the art will appreciate that other arrangements of detectors can be practiced in accordance with various embodiments of the present invention. In some embodiments, the sensor uses simultaneous, or substantially simultaneous detection via a plurality of detectors. Further, detectors can be placed where they are not directly illuminated by the beam, including along the periphery of the sample tube or on the surface of the tube under the criss-crossing or scanning beam. As used herein, a criss-crossing beam is a beam that is bent or reflected at least one time such that it passes through the sample interaction region multiple times. This can provide increased coverage in the sample interaction region. A scanning beam is a tightly focused beam that moves to cover the entire sample interaction region. The tight focus allows a high beam intensity necessary for small particle detection. In fact, the beam intensity may be so high that if the beam were not scanned, the heat from the beam would damage the sensor.

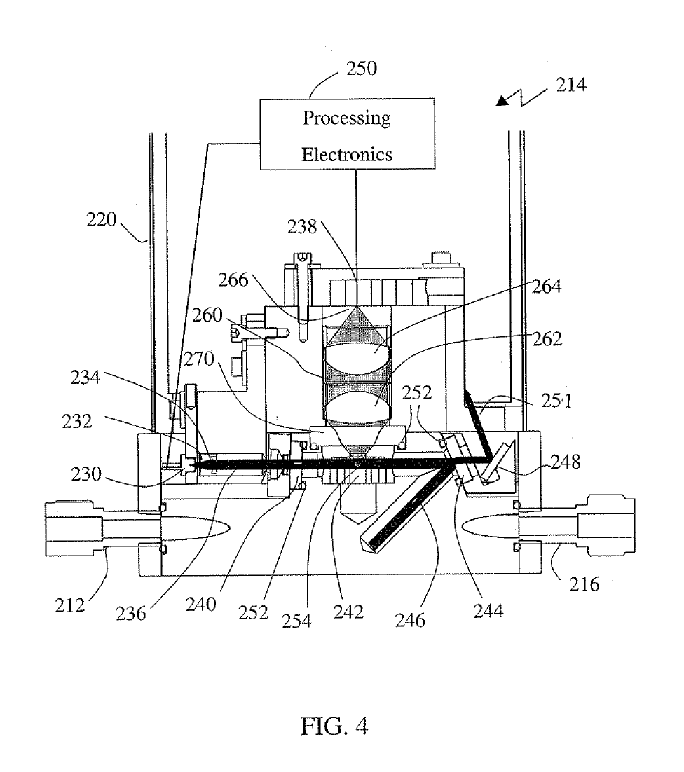

FIG. 4 is a diagrammatic view of an in-line particle sensing system in accordance with an embodiment of the present invention. System 214 bears many similarities to system 114, and like components are numbered similarly. System 214 includes electronics enclosure 220 that includes processing electronics 250 which are coupled to illumination source 230 and detector 238. Further, system 214 includes inlet 212 and outlet 216 through which process gas or specialty chemicals flow. The entire flow path from inlet 212 to outlet 216 is not illustrated in FIG. 4, because some of the flow path is not shown at the cross section and some of the flow path is perpendicular to the plane of the page.

Source 230, which is preferably a laser illumination source, generates laser illumination 232 that enters collimating optics 234 to generate collimated beam 236. Collimated beam 236 passes through high-pressure transparent member 240 into sample interaction region 242 and ultimately impinges high-pressure transparent/reflective member 244. Member 244 reflects a portion of collimated beam 236 as indicated at reference numeral 246. Further, a portion of beam 236 passes through member 244 and is reflected by mirror or other suitable optical surface 248 as indicated at beam 251. Each of high-pressure transparent members 240, 244 are optically configured to pass and/or reflect collimated beam 246 as appropriate. Additionally, members 240 and 244 are thick enough and selected from a material that is strong enough to withstand the entire operating pressure to which system 214 is exposed. For example, the pressure within interaction region 242 may be on the order of 3000 pounds per square inch or higher. Members 240 and 244 are accordingly optical members that are configured to withstand that pressure. Additionally, suitable seals or other joints to fit the tube or transparent members may be provided to facilitate high-pressure sealing. The entire gas flow chamber or sample interaction region 242 should be designed robustly to withstand very high pressures. This is particularly important since many gases in a semiconductor fab are very toxic or flammable, and gas leakage could be dangerous. Interaction region 242 is preferably constructed with materials that will not contaminate the gas or react with the gas. Stainless steel is the preferred material. Quartz or sapphire is preferred window materials for transparent members 240 and 244. Sealing members 252 may be o-rings made from various materials depending on the gas or fluid in the chamber. Additionally, or alternatively, sealing members 252 can be metal o-rings. Collimated beam 236, after it has interacted with particles in sample interaction region 242, exits the sample interaction region 242 through transparent member 244. Preferably, stray laser light is kept away from photodetector optics and photodetector 238 to prevent masking of the signal from the particles.

Gas flow within sample interaction region 242 is preferably from nozzle 254 exiting from the plane of the page. Accordingly, a gas passing through nozzle 254 is essentially being conveyed at an angle that is substantially orthogonal to the angle of collimated beam 236. Sizing nozzle 254 can control the gas flow velocity through sample interaction region 242. Within interaction region 242, particles entrained in the gas exiting from nozzle 254 will cause scattering of the illumination within beam 236. This scattering is detected in beam 260 which passes through detection optics 262 and 264. Optics 262 and 264 cooperate to focus an image of the gas interaction region and scattered illumination upon photodetector 238 at location 266. As illustrated in FIG. 4, the scattered illumination is conveyed through a third high-pressure optical member 270 which is also optically configured to provide high quality illumination transmission therethrough, but is also physically configured to withstand the internal pressures of sample interaction region 242. Further, member 270 can be sealed with suitable sealing members 252, as illustrated.

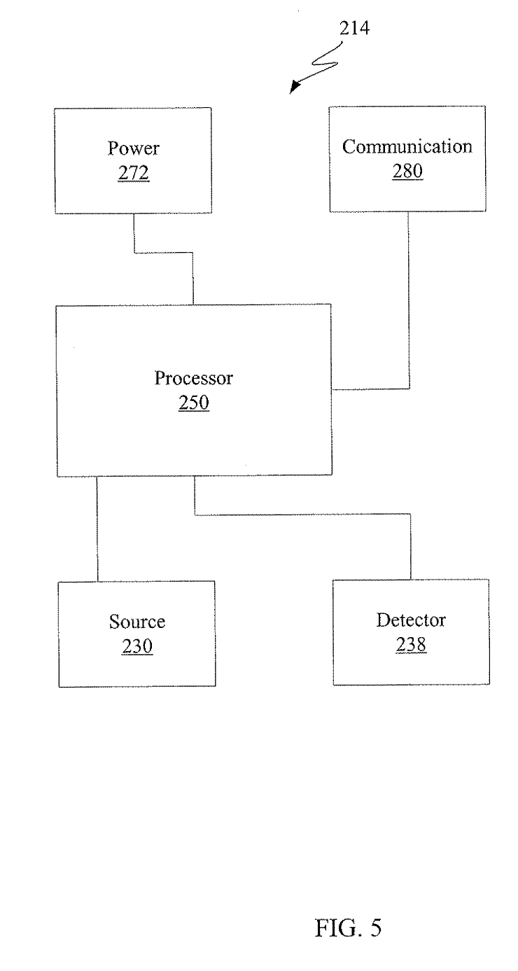

FIG. 5 is a diagrammatic view of an in-line particle sensing system in accordance with an embodiment of the present invention. System 214 includes processor or processing electronics 250, power module 272, and communication module 280. Processor 250 is operably coupled to illumination source 230 and to one or more detectors 238. Power module 272 preferably includes a source of energy such as a battery, rechargeable or otherwise, that provides electrical power to sensor 214. Additionally, or alternatively, power module 272 may include circuitry to condition power from an available wall socket, to power the sensor and/or charge a battery (which could provide backup operation in the case of a power failure). Processor 250 is preferably a microprocessor, but may be any suitable processing electronics that are able to sense, or otherwise detect, particles using detector 238 and provide usable information to communication module 280 to convey information about particle detection. Communication module 280 is coupled to processor 250 and is configured to communicate information regarding particle detections. Module 280 may be a wireless communication module, a wired communication module, or any combination thereof. Suitable examples of wired communication include the Universal Serial Bus (USB) communication standard, as well as known Ethernet communication. Examples of suitable wireless communication include the known Bluetooth communication protocol, as well as the known ZigBee communication protocol.

Source 230 can be any suitable device capable of generating electromagnetic energy, visible or otherwise, that can interact with particles in such a way that the illumination interaction can be detected. Preferably, source 230 is a laser illumination source with a relatively short wavelength such as a blue laser. Detector 238 can be any suitable device that can detect the illumination from source 230. Preferably, detector 238 is simply a photodetector having sensitivity at the wavelength of illumination provided by source 230. However, any device that is able to generate an electrical signal based upon electromagnetic energy impinging thereon may be used.

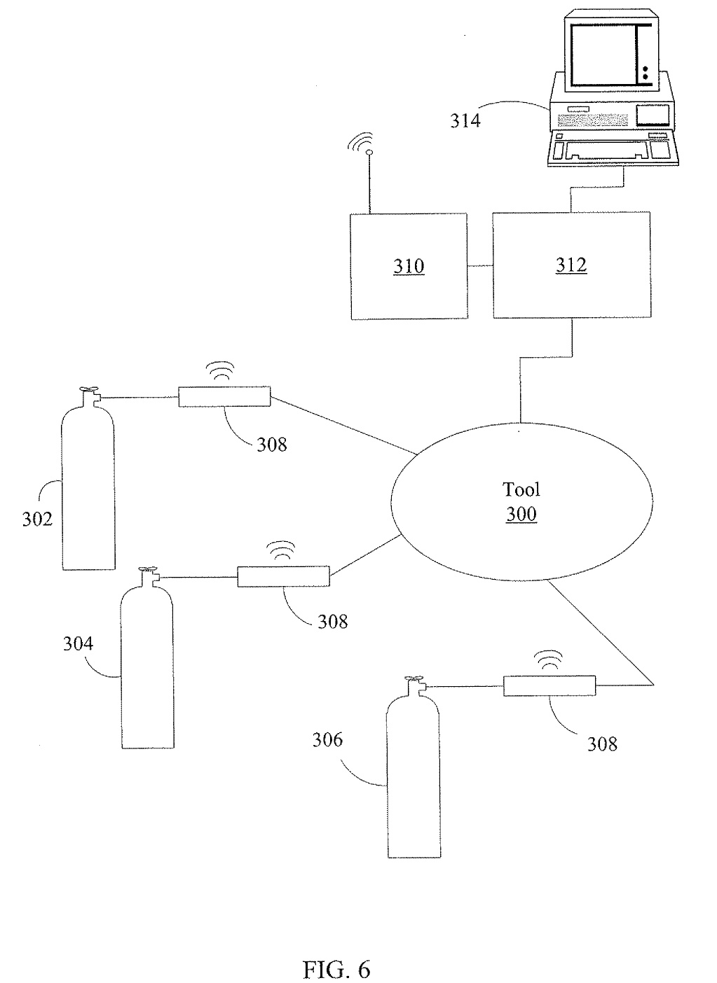

FIG. 6 is a diagrammatic view of a semiconductor processing tool 300 operably coupled to sources 302, 304, 306 of specialty gases. Each source 302, 304, 306 is operably coupled to tool 300 via respective in-line particle sensing systems 308. Systems 308 can report, either wirelessly or otherwise, particle detection events occurring in real-time or otherwise. Particle detection information provided by systems 308 is conveyed to receiver 310 that is operably coupled to semiconductor tool controller 312. Controller 312 also provides an interface, illustrated diagrammatically at 314, for a technician or operator. Accordingly, as any of systems 308 detect particles flowing in an amount or quantity that is greater than a selected threshold, the tool controller 312 can automatically halt the process or generate an alarm or other suitable indication to the operator via interface 314. Additionally, when problems with tool 300 are discovered, an operator utilizing interface 314 may review real-time data as well as stored historical information provided by systems 308 to determine if particles that may have contaminated tool 300 were introduced from any of sources 302, 304, 306.

Embodiments of the present invention provide a number of advantages in a number of semiconductor processing applications. For example, a process gas manufacturer or supplier is generally concerned about the gas cleanliness that is supplied or may have a dispute with a customer about the gas cleanliness. The gas supplier may install an in-line particle sensing system on the gas bottle and monitor the gas as it leaves the bottle. When the customer notices an apparent burst of particles, the gas supplier can search the particulate level recorded by the sensing system and verify if the gas was contaminated as it left the bottle. This is an example of post-contamination troubleshooting.

Another example of advantages provided by embodiments of the present invention for semiconductor processing systems is when particles are detected in a semiconductor fab or other facility. In-line particle sensing systems can be connected at various points in specific gas lines to try to determine the source of the particles. This is an example of distributed particle sensing employing embodiments of the present invention.

Yet another example of advantages provided by embodiments of the present invention is using in-line particle sensing systems to sense a particle burst and cause a process shutdown, valve closure, or alarm to prevent damage to work in process. This is an example of an event detection where real-time information or substantially real-time information can be used to prevent additional problems. Further, the particulate level may be monitored over time and various quality control methods can be applied to improve the particulate level.

Another advantage of embodiments of the present invention arises from the fact that a number of gas users will stop using gas when the pressure drops to a certain level because they have learned from experience that taking the last gas in the bottle increases the chances of contamination. However, if a user installs an inline particle sensor in accordance with embodiments of the present invention, the user may be able to use more of the gas from the bottle because the user can detect when the contamination starts to rise.

Although the present invention has been described with reference to preferred embodiments, workers skilled in the art will recognize that changes may be made in form and detail without departing from the spirit and scope of the invention.

What is claimed is:

1. An in-line particle sensor comprising:
a sensor body having an electronics enclosure and a flowthrough portion with a fluid inlet, a fluid outlet, a sample interaction region and a fluid path extending through the sample interaction region from the fluid inlet to the fluid outlet;
an illumination source disposed to provide light through at least a portion of the sample interaction region;
an illumination detector disposed to detect illumination variation resulting from illumination impinging at least one particle in the flow path in the sample interaction region;
communication electronics operably coupled to the illumination detector to provide an indication of the at least one particle sensed by the illumination detector; and
wherein the sample interaction region is configured to withstand high operating pressure.

2. The sensor of claim 1 wherein the communication electronics are wireless communication electronics.

3. The sensor of claim 1 wherein the communication electronics are wired communication electronics.

4. The sensor of claim 3 wherein the wired communication electronics are Ethernet communication electronics.

5. The sensor of claim 3 wherein the wired communication electronics are USB wired communication electronics.

6. The sensor of claim 1, wherein the sample interaction region is sealed, but includes a plurality of transparent windows that convey illumination from the illumination source, but which cooperate to seal the sample interaction region.

7. The sensor of claim 6, and further comprising a detection window that also cooperates to seal the sample interaction region and which passes illumination variations caused by the at least one particle to the illumination detector.

8. The sensor of claim 7, and further comprising detector optics disposed to provide a focused image of the sample interaction region to the illumination detector.

9. The sensor of claim 1, wherein the sensor is configured to appear similar to a mass flow controller.

10. The sensor of claim 1, wherein the flowthrough portion is constructed from a single piece of metal.

11. The sensor of claim 1, wherein the metal is stainless steel.

12. The sensor of claim 1, wherein the illumination source is a laser.

13. The sensor of claim 12, and further comprising collimating optics disposed to collimate the laser illumination from the illumination source.

14. The sensor of claim 1, wherein the illumination and the fluid flow are substantially orthogonal to one another in the sample interaction region.

15. The sensor of claim 1, and further comprising a nozzle interposed in the fluid path and configured to provide a selected fluid flow rate.

16. A system for providing fluid to a semiconductor processing tool, the system comprising:
a source of pressurized fluid having a valve and an outlet;
a particle sensor operably coupled to the outlet, the particle sensor including:
a sensor body having an electronics enclosure and a flowthrough portion with a fluid inlet, a fluid outlet, a sample interaction region and a fluid path extending through the sample interaction region from the fluid inlet to the fluid outlet;
an illumination source disposed to provide light through at least a portion of the sample interaction region;
an illumination detector disposed to detect illumination variation resulting from illumination impinging at least one particle in the flow path in the sample interaction region;
communication electronics operably coupled to the illumination detector to provide an indication of the at least one particle sensed by the illumination detector; and
wherein the sample interaction region is configured to withstand the pressure of the source of pressurized fluid.

17. The system of claim 16, and further comprising an additional particle sensor operably interposed between the first particle sensor and the semiconductor processing tool.

18. The system of claim 17, wherein each of the particle sensors conveys indications of particles to a controller of the semiconductor processing tool.
